(19) United States
(12) Patent Application Publication
(10) Pub. No.: US 2005/0258111 A1
(43) Pub. Date: Nov. 24, 2005

(54) Method for transporting water in a contaminated environment

(76) Inventor: Raymond Michael Brandl, Blooming Glen, PA (US)

Correspondence Address: Raymond Michael Brandl, PO Box 162, Blooming Glen, PA, 18911, US

(21) Appl. No.: 10/780,688

(22) Filed: Feb. 19, 2004

Related U.S. Application Data
(60) Provisional application No. 60/456,923, filed on Mar. 21, 2003.

(51) Int. Cl. C02F 1/00

(52) U.S. Cl. 210/767

(57) ABSTRACT

The NBC (Nuclear Biological Chemical) Water Distribution System for transporting water or just refilling water or other form of liquid into canteens from a water-bull faucet or other types of faucets or a five-gallon water can seems to be possible. The inventive device can fill up a canteen in thirty to forty seconds depending on the pressure that the human hands could squeeze that acts like a water pump into the two connecting devices. The present invention can be used in training or combat environment, which will improve troop welfare due to the present invention and its ability to transfer water.

### RELATED APPLICATION

This application is a continuation-in-part of and claims priority to U.S. Provisional Application Ser. No. 60/456,923 filed on Mar. 3, 2003, entitled “NBC Water distribution System,” the entire teachings of both of which are incorporated herein by this reference.

### BACKGROUND OF THE INVENTION

1. Field of the Invention

The present invention relates generally to the NBC (Nuclear Biological Chemical) Water Distribution System for transporting water from a main water source from a five-gallon water can, water-bull, or a conventional home or building water faucet to American or Allied personnel. The portable water source called a canteen can be carried which can be refilled on the ground in many different scenarios.

2. Description of the Prior Art

As our world is becoming more hostile and our troops are being deployed to places that may not be practical to re-supply our troops, it would be more practical if water could be re-supplied in a more efficient manner. It can be appreciated that canteens have been in use for training or combat for years. Typically, canteens are comprised of a one or two-quart canister that can be filled up with water or other forms of liquid, that is portable, light weight, and efficient. A NBC drinking module on top of the canteen is used during times that soldiers can drink from in a contaminated area though their gas masks. To refill a canteen, the traditional ways is by twisting off the top and pour directly into the canteen itself or exchange the canteen for another that are full.

Other ways to drink from a canteen is by twisting the top of the canteen counter clock-wise until the canteen top is off and then pour the liquid of choice directly in the mouth or another drinking container.

The main problem with the conventional canteen setup is that there is no way to refill the canteen in contaminated areas in training or on the battlefield. Many times in contaminated combat zones, military trucks will transport fresh water canteens in exchange for the American or Allied canteens. This can be a dangerous effort to exchange old canteens for new ones, especially in a combat environment. Then let it be known that without proper fluids in the body, it can ultimately cause dehydration, the soldiers would be worthless in defensive or offensive positions on the battlefield if proper fluids were not provided.

While these canteens are suitable for the particular purpose on the battlefield in which they address, they are not as suitable for refilling without removing the canteen top. The main problem with the canteens is that they can't be refilled in a contaminated areas on the battlefield without removing the canteen top that twists on or off, in doing so could contaminate the canteen.

### SUMMARY OF TITLE INVENTION

In the view of the foregoing disadvantage inherent in the known types of the canteens and how they where refilled now presents in the prior art, the present invention provides a new (Nuclear Biological Chemical) NBC water distribution system constructed wherein the same can be utilized for refilling canteens that can be engaged in a combat or training environment.

A primary object of the present invention is to provide a NBC water distribution system that will over come the shortcomings of the prior art on how the canteens may be refilled. The present invention is to provide a way for Americans and Allies to refill their canteens in a contaminated environment safely and swiftly.

Another aspect to the present invention is that it doesn't require any batteries, or pumps required to fill the canteen.

The present invention is a system and method of transporting water in and out of contaminated areas with a conventional military canteen, five-gallon water can, a water tank, or a conventional home or building water faucet. More particularly, an illustrative embodiment of the present invention includes a chemical resistant hose, a NBC drinking connector, a five-gallon water-connecting cap with attached main vacuum connector, a drainage hose, a drainage plug, and a plastic storage bag.

In the view of the foregoing disadvantage inherent in the known types of the canteens and how they are refilled now presents in the prior art, the present invention provides a new (Nuclear Biological Chemical) NBC water distribution system constructed wherein the same can be utilized for refilling canteens that can be engaged in a combat or training environment.

The general purpose of the present invention, which will be described subsequently in greater detail, is to provide a new NBC water distribution system that can be deployed along with the Americans or allied military to refill their canteens more safely in the areas that may be contaminated.

The present invention would take about thirty to forty seconds while the canteen is being compressed on the widest part squeezing inward from both sides causing the pressure to exhale air into the feeding tank and inhale water in the canteen in return.

### BRIEF DESCRIPTION OF THE DRAWINGS

For a better understanding of the present invention, reference is made to the following description of an exemplary embodiment thereof, considered in conjunction with the accompanying drawings in which like reference character refer to the same parts throughout the different views. The drawings are not the necessarily to scale, emphasis instead being placed upon illustrating the principles of the invention.

FIG. 1 Side view of the present invention disassembled

FIG. 2 Diagram that shows part-by-part of the present invention in a diagram on how to put together.

FIG. 3 Attached view of the present invention

FIG. 4 Action view of the top of the present invention being used

FIG. 5 Water-Bull view or faucet to the canteen

FIG. 6 Plastic storage bag view

FIG. 7 Top view of a canteen and five-gallon water can top

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

### DETAILED DESCRIPTION OF THE DRAWINGS

Turning now descriptively to the drawings, in which similar reference characters denote similar elements throughout the several views, that attached figures illustrate a NBC Water Distribution System, which comprises of number illustrating parts of the invention and components in relevance to make the invention work. Throughout the figures, the numbers will correspond to each part and are as follows: [1] NBC Drinking Connector, [2] Chemical Resistant Hose, [3] Five-Gallon Water Connecting Cap with attach Main Vacuum Connector, [4] Drainage Hose, [5] Drainage Plug, [6] Plastic Storage Bag, [7] Canteen, [8] Canteen Cap, [9] NBC Canteen Plug Cap, [10] Five-Gallon Water Can, [11] Five-Gallon Water Cap, [12] Five-Gallon Air Releaser, [13] Human Hands Squeezing Canteen, [14] Water-Bull Faucet, [15] NBC Water Hole.

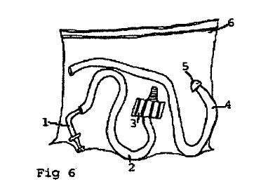

The NBC Water Distribution System has very few parts as seen on FIG. 6. It is composed of a NBC Drinking Connector as number [1], a Chemical Resistant Tubing as number [2], a Five-Gallon Water Connecting Cap with attached Main Vacuum Connector that can be attached to a Five-Gallon Water Can, Water-Bull, or a conventional home or building water faucet as number [3], A Drainage Hose as number [4], A Drainage Plug as number [5], and a Plastic Storage Bag as number [6].

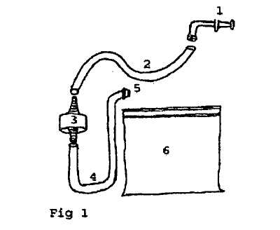

As shown in FIG. 1 are the parts in a separation state. This has an advantage for easy cleaning and part replacements.

As for taking apart the invention, one has to know how to put the module together separating the confusion of where each part might go.

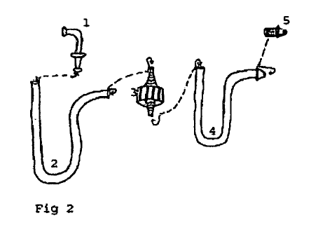

In FIG. 2, shows an illustration of how this invention is disassembled, as it would be to reassemble. With the dotted lines with arrows disminishing the confusion of any assembly difficulties.

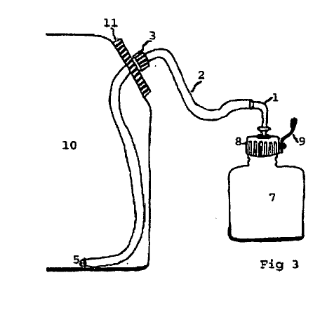

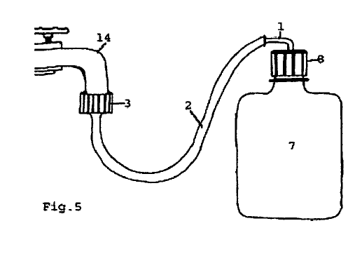

Connecting the invention to a five-gallon water can as number [10] in FIG. 3, is as easy as connecting your garden hose to a standard home faucet. The five-gallon water connecting cap attach main vacuum connector as number [3] in FIG. 1, is connected to a drainage hose as number [4] in FIG. 1, it is not necessary to have a chemical resistant type of material because it isn't exposed to a toxic liquid. With the Drainage Hose number [4] in FIG. 3, inside the five-gallon water can number [10] in FIG. 3, it would be appropriate to attach a weighted plug called a drainage plug number [5] in FIG. 3, so that the drainage hose isn't floating on top of the liquid. With the attached drainage plug as number [5] in FIG. 3, it would also serve as an advantage for reaching lower levels of liquid in tight corners of the five-gallon water can [10] in FIG. 3. The exception for not having the drainage hose [4] in FIG. 5, and drainage plug [5] in FIG. 3, is when connecting the invention to a water-bull or other types of faucet as number [14] in FIG. 5. This same concept could also be connected to a building or home type faucet, leaving the drainage hose [4] in FIG. 2, drainage plug [5] in FIG. 2, in it's portable plastic storage bag as number [6] in FIG. 6.

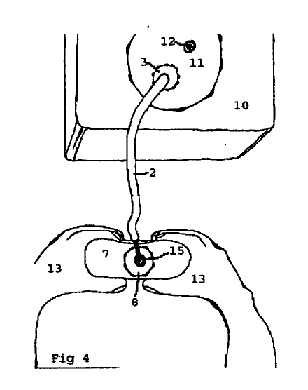

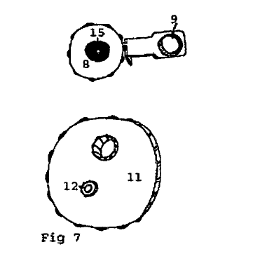

To get water to enter the Canteen [7] in FIG. 4 is to squeeze the canteen [7] as illustrated in FIG. 4. FIG. 4 is displaying an airtight seal that includes the five-gallon air releaser [12] in FIG. 7, is screwed tightly and is connected to a five-gallon water cap [11] in FIG. 7 to the current invention connected and to the canteen [7] in FIG. 4. When human hands [13] squeezes the canteen [7] with the current invention connected, it will act like a self contained liquid pump from the water source to the canteen [7] in FIG. 4.

The concept of transporting water from some of the conventional water faucets is to leave components [4], [5] in a plastic storage bag [6] in FIG. 6. This will prevent any shortcomings of a tight seal making the current invention expendable to how drinking liquid is retrieved.

For lightweight storage, a plastic storage bag [6] in FIG. 6. Is what is appropriate with a double tight seal that changes colors when properly sealed as shown in FIG. 6. This leaves the current invention flexible and lightweight to the advantage of the soldier out in the field or in combat.

In FIG. 7 shows two parts that the invention could connect too. The canteen cap number [8] in FIG. 7 has a NBC Water hole as number [15] in FIG. 7, which the current invention connects to in order to fill the canteen with drinkable liquid. This is essential for the soldier to have a canteen cap [8] in FIG. 7, for the current invention to work. The NBC canteen plug cap as number [9] in FIG. 7 is to safe guard the canteen water hole when not in using the current invention.

Also in FIG. 7 there is a five-gallon water cap [11], which is in the current invention can also connected to for any retrieval of drinkable liquids. But for the retrieval of drinkable liquids it is essential that the five-gallon air releaser is tightly screwed down to prevent any leakage of air or other contaminates from entering into the five-gallon water can [10] FIG. 3, and FIG. 4.

1. Providing that the NBC Water Distribution System can have access to a water faucet or a five-gallon water can, said the invention can be disassembled and reassembled for easy cleaning, where said the parts can come apart and be washed in water or bleach to clean dirt, debris, or other contaminates.

2. The method of providing that the prior invention can be said taken apart, parts can easily be said replaced if broken or unserviceable for the current invention to function properly.

3. The method of providing a plastic storage bag is another advantage due to said tight spaces and said being lightweight and said changes color when properly sealed.

4. The method of the prior invention said can be connected to a water-bull and also said a normal conventional home or building faucet for easy retrieval of water.

5. The method of said a double seal plastic storage bag provides extra said double sealed so that debris, sand, dirt, or other harmful said agents wouldn't affect the current invention.

6. The method of said chemical resistant hose on the current invention is to protect the invention from said sprayed contaminates or other harmful debris so they wouldn't eat away at the said current invention.

7. The method of said non-chemical resistant hose that is separate from the chemical resistant is needed, because said the non-resistant hose isn't exposed to any harmful contaminate. Leaving said non-chemical resistant hose more flexible and said the ability to reach each all corners of the five-gallon water can.

8. The method of connecting the NBC Water Distribution System to a said water faucet can be easily obtained if said user disconnects the drainage hose with the attached drainage plug.

9. The method of said connecting the drainage hose and said five gallon connecting cap could be separated when connecting to a five-gallon water bull or other types of faucets.

10. The method of transporting water from the five gallon water can to the canteen is said that squeezing the canteen will act as a self contained pump.

11. The method of transporting water from a water bull or other types of water faucet is said to disconnect the drainage hose with the attach drainage plug and put back into the said plastic storage bag for the said five gallon water cap to fit correctly.
